(19) United States
(12) Patent Application Publication
(10) Pub. No.: US 2007/0248817 A1
(43) Pub. Date: Oct. 25, 2007

(54) Self-Adhesive Film with Air Channels and/or Air Chambers

(75) Inventors: Marco Sieber, Horw (CH); Reto Sieber, Sigigen (CH)

Correspondence Address: ST. ONGE STEWARD JOHNSTON & REENS, LLC, 986 BEDFORD STREET, STAMFORD, CT, 06905-5619, US

(73) Assignee: Uzin Tyro AG

(21) Appl. No.: 11/740,544

(22) Filed: Apr. 26, 2007

Related U.S. Application Data
(63) Continuation of application No. PCT/EP05/10960, filed on Oct. 12, 2005.

(30) Foreign Application Priority Data
Oct. 26, 2004 (DE) DE102004052022.4

(51) Int. Cl. B32B 27/04; B32B 27/12; B32B 5/16; B32B 7/12; B32B 3/30

(52) U.S. Cl. 428/343; 442/149; 442/151; 428/323; 428/167

(57) ABSTRACT

A self-adhesive film to adhesively attach a floor covering, in particular a rug, to a floor, in particular a parquet floor, or to a stairway, is provided comprising a support layer made of plastic film that is coated with an adhesive coating on a top surface facing the floor covering and on a bottom surface facing the substrate, in particular the floor or stairway. The self-adhesive film is designed with air channels and/or air chambers between the self-adhesive film and the floor covering at least on its top surface facing the floor covering in a plane that runs perpendicular to the thickness of the self-adhesive film.

### CROSS REFERENCE TO RELATED APPLICATIONS

This application is a continuation under 35 U.S.C. §111 of International Application No. PCT/EP2005/010960 having an International Filing Date of Oct. 12, 2005, which claims the benefit of priority of DE 10 2004 052 022.4 having a filing date of Oct. 26, 2004.

The invention pertains to a self-adhesive film for the adhesive attachment of flat, flexible materials such as floor coverings, carpets, sheeting, posters or textiles.

In general, self-adhesive films for the purposes of installing flat coverings such as floor coverings or the like are known in the art.

There are numerous ways to fasten flexible, flat materials such as a PVC or CV floor covering onto a floor or stairway. Newer methods consist of applying self-adhesive films equipped with an adhesive coating on both sides onto the entire floor surface. The floor covering to be installed is then placed on top of the self-adhesive film.

Patent application PCT/EP01/08314 describes self-adhesive films for the purposes of installing floor coverings, wherein the support layer is made to be adhesive-embedding on at least its bottom surface. IP0937761 A1 describes dual-sided adhesive carpet installation strips, both sides of which are provided with non-fogging, pressure sensitive adhesives over the entire surface. German Offenlegungsschrift DE 3041074 A1 describes adhesive strips for installation of floor coverings, the adhesive coating of which facing the substrate contains points of adhesion. On the other hand, the side facing the floor covering to be installed contains a coating of adhesive on the entire surface. Known adhesive films are either permanently adhesive or can also be removed from the floor.

Self-adhesive films known up to this point are either partially permeable with respect to water vapor or are open to water vapor, but in all cases the side of the adhesive films facing the floor covering to be installed is fully treated, in other words the entire surface is evenly coated with adhesive. This type of adhesive strip presents numerous disadvantages during installation. In particular, where the installation of flexible, flat floor coverings such as PVC webs or CV webs that have nearly smooth backs is concerned, it is rarely possible to apply the floor covering onto the top of the self-adhesive film just installed onto the floor without producing any air pockets. The cushions of air trapped between the self-adhesive film and the floor covering cannot escape since the entire surface of the self-adhesive films is coated with adhesive, thereby hermetically sealing the air cushions thus formed. When the installed floor covering is walked upon, the air cushions are compressed and pushed together, resulting in clearly visible bubbles that remain more or less permanently depending on the permeability of air through the floor covering. Another disadvantage of providing pressure sensitive adhesive onto the entire side of the self-adhesive film facing the floor covering becomes clearly noticeable when the floor covering is applied. As soon as the floor covering first comes into contact with the pressure-sensitive self-adhesive film, it permanently adheres and can no longer be removed from the self-adhesive film for all practical purposes. Corrections are thus impossible. Thus, the problem in the installation of flexible materials onto self-adhesive films known up until now is that it has been impossible to install flat products free of tension and free of bubbles.

The object of the invention is thus a self-adhesive film that can overcome the disadvantages of the prior art and that enables bubble-free and tension-free installation of flat, flexible materials such as floor coverings like PVC, CV, polyolefin or carpets, sheeting, posters or textiles, while maintaining ease of use.

The self-adhesive film according to the invention, which can be used to adhesively attach a floor covering, in particular a carpet, onto a floor, in particular a parquet floor, or onto a stairway, or to adhesively attach sheeting, posters or textiles, in some embodiments comprises a plastic film support layer coated with a layer of adhesive on a top surface facing the floor covering and on a bottom surface facing the substrate, in particular the floor or stair, and is designed with air channels and/or air chambers on at least its top surface facing the floor covering, sheeting, poster or textile, said air channels and/or air chambers located between the self-adhesive film and the floor covering, sheeting, poster or textile in a plane that runs perpendicular to the thickness of the self-adhesive film.

The purpose of the self-adhesive film according to the invention is in particular to adhesively attach a floor covering to a floor or to a stairway. Non-limiting examples of flooring can be parquet, terrazzo, stone, pavement, wood, carpeting or the like. The self-adhesive film comprises a plastic film support layer whose top surface facing the floor covering and bottom surface facing the floor are coated with an adhesive coating. The self-adhesive film according to the invention can be designed with a minimum width of 150 mm for wide area coverage of the floor or stair to be covered with the floor covering, wherein the support layer can be designed to be uneven or rough, at least on its top surface, such that defined air chambers and/or air channels remain between the self-adhesive film and the floor covering.

The invention provides that at least the top surface of the self-adhesive film facing the floor covering is provided with a coating of adhesive characterized by defined air chambers and/or air channels that remain intact, or largely so, after the floor covering is installed. In some embodiments, the air chambers and/or air channels remain intact at least as long as necessary to allow the air trapped between the self-adhesive film and the floor covering to escape. In some embodiments, air chambers and/or air channels remain intact permanently.

The air channels and/or air chambers can be produced from first areas, or recesses, in the adhesive layer or by having a thinner adhesive layer thickness in some places. These air channels and/or air chambers can run parallel to the web direction of the self-adhesive film or perpendicular thereto, or can be at any arbitrary oblique angle relative to the web direction. Second areas contain a normal adhesive coating as before, which is thicker than in the first or recessed areas. In some embodiments, the first or recessed areas do not include adhesive coating. In some embodiments, the air channels can be elongated. In some embodiments the air channels can be elongated and without interruption.

In some embodiments, the air channels and/or air chambers can be isolated. In some embodiments, the air channels and/or chambers can be connected to one another.

In some embodiments according to the invention, the width of the air channels can be at most 15 mm, at most 5 mm, at most 3 mm, at most 1.5 mm, or at most 1 mm.

The air chambers can be produced by recesses in the adhesive coating or by making the layer thickness of the adhesive coating thinner in some places.

The air chambers can have any arbitrary shape. Non-limiting examples include square, rectangular, triangular, trapezoidal, rhombic, circular and oval. In the case of multi-angular shapes, the diameter, i.e. the smallest distance between center of the recess shape and the edge of the recess shape, can be at most 10 mm, at most 5 mm, at most 3 mm, at most 1.0 mm, or at most 0.5 mm. A person of ordinary skill should understand that where numbers are used in the specification the term “about” implicitly modifies those numbers to account for ordinary experimental error that occurs in measurements.

The air chambers can absorb the air cushions formed between the self-adhesive film and the floor covering when the floor covering is installed, and can prevent them from being compressed into bubbles when the floor covering is walked upon.

In some embodiments, the air chambers can maintain their shape at least as long as it takes for the trapped air escape.

Instead of or in addition to the air channels and/or air chambers created by means of different first and second areas, at least the top surface of the self-adhesive film facing the floor covering can be provided with an adhesive coating which is characterized as being essentially uneven and rough. Microscopically, the roughness of this top adhesive coating is caused by a high-low structure. The distance from the lowest point to the highest point can be increased or decreased depending on the desired air absorption capacity.

According to embodiments of the invention, the high-low structure of the top surface of the self-adhesive film has an average roughness of for example, from 1-300 μm, from 5-200 μm, from 10-150 μm, from 15-100 μm, or from 20-75 μm. The roughness can be attained by adding comparatively coarse fillers, for example. The average particle diameter in this case is in the range of from 0.1 to 10 times the thickness of the adhesive coating of the top side of the self-adhesive film, or in the range from 0.3 to 5 times, or in the range from 0.5 to 3 times the thickness thereof.

According to the invention, due to the unevenness of the top surface of the self-adhesive film facing the floor covering, said unevenness being produced as a result of air channels and/or air chambers and/or roughness, centers of adhesion occur when the floor covering is installed. These centers of adhesion are believed to allow the floor covering to be set in place with no tension, and if necessary removed as well prior to applying any significant pressure, for example prior to walking on it, without significantly reducing the final bond strength of the self-adhesive film.

According to an embodiment of the invention, the self-adhesive film can also be made to be adhesives-embedding at least on the bottom surface. The plastic film of the support layer can be coronized at least on its bottom surface, and it can furthermore also be provided with a coat of primer and/or contain co-extruded adhesion promoters. Suitable primers can also function as a barrier against the penetration of additives and/or softening agents. It is also possible to admix the primer into the adhesive coating of at least one of the surfaces. As mentioned, the self-adhesive film can contain adhesion promoters, at least on the bottom surface, that are co-extruded during the manufacturing process, for example for the purpose of adhesive embedding.

In some embodiments according to the invention, the adhesive-embedding surface of the support layer can be designed as a layer and/or the support layer itself can consist of the adhesive-embedding material,

In general, it is possible to implement any of the adhesive-embedding design options described above, at least on the bottom surface of the self-adhesive film, or to combine two or more of these options, wherein the adhesive-embedding design can also be implemented for at least the top surface, for example, if residue-free detachability of the self-adhesive film is desired both from the substrate, floor, or stairs, as well as from the covering to be installed, for example floor covering, rug or poster.

Furthermore, the support layer can be designed such that it contains at least one section that acts as a barrier against the penetration of additives and/or softening agents. In this regard, according to an embodiment of the invention, the barrier can essentially be the adhesive-embedding surface. In general, the additives and/or softening agents can derive from the self-adhesive film adhesives themselves or from the coverings used, such as PVC, CV floor coverings or PVC film posters. This barrier can prevent the properties of the original adhesive coating from changing negatively. This can ensure that the self-adhesive film according to the invention maintains its desired bond strength over a longer time period and does not lose its detachability, in particular residue-free removability, due to changes in the individual layers of the self-adhesive film.

It can also be advantageous to design at least the bottom surface of the support layer to be essentially flat. It can also be advantageous to design the adhesive coating at least on the bottom surface to be essentially flat. The essentially flat design of the bottom surface of the support layer and/or adhesive coating can provide a particularly reliable adhesive attachment of the self-adhesive film according to the invention, wherein centers of adhesion that occur due to stronger adhesion only at points as a result of unevenness are avoided, thereby achieving full surface anchoring. This can improve the manageability of the self-adhesive film according to the invention and facilitate the essentially residue-free detachability of the self-adhesive film according to the invention from the substrate.

To accomplish an especially reliable and durable adhesive fastening of the floor covering by means of the self-adhesive film according to the invention, while at the same time accomplishing residue-free detachability from the floor, it is moreover preferred that the bottom surface have an adhesive coating with a bottom bond strength that is less than the bond strength of the adhesive coating of the top surface. To this end, different adhesives can be used on each of the two surfaces or the same adhesive can be used on each of the surfaces.

In some embodiments of the invention, the different adhesive strengths, i.e. bond strengths, of the two surfaces of the adhesive coating can be accomplished by means of different average application weights, wherein the surface with the higher bond strength has a higher average adhesive application weight.

In some embodiments the average adhesive application weight in the dry state on at least the top surface is in the range of from 5 to 250 g/m², and in particular on at least the bottom surface it is from 5 to 100 g/m², in particular from 10 to 80 g/m². The bond strength of the respective adhesive coating is determined by the selection of the adhesive and on the application weight.

Proven adhesives include an acrylate-based dispersion, for example enriched with resins and containing UV and anti-aging protection, wherein any other suitable dispersion-based or solvent-based adhesive can be used, as can an adhesive based on UV, electron-beam or thermal cross-linking, as well as a hot melt-based adhesive; any of these can, in particular, also be permeable to water vapor. It is appropriate for adhesives to be selected that exhibit as constant a bond strength as possible with respect to the floor as well as to the floor covering over a certain time period. The adhesive coating of the bottom and/or the top surface can be full-coverage, but it can also be applied in sections.

In some embodiments, the adhesive of at least one surface is resistant to softening agents. In some embodiments, the adhesive of the bottom and the top surface are resistant to softening agents.

Through the suitable selection of adhesive coating or adhesives together with the support layer, it can be ensured according to the invention that the self-adhesive film according to the invention can be detached residue-free at least from the substrate, from example the floor, but depending on the circumstances also from the covering to be affixed, for example the floor covering, rug, or poster, at all times.

The bond strengths of the two adhesive coatings of the self-adhesive film are preferred to be determined by the selection of the adhesive and by the application weight.

Preferably, the bond strength of the bottom surface measured according to DIN EN 1939 (dated November 1996), measured as an adhesive coating peeling force, is in a range from 0.5 N/25 mm to 15 N/25 mm, from 1.0 N/25 mm to 10 N/25 mm, from 2.0 N/25 mm to 8.0 N/25 mm, or from 3.0 N/25 mm to 6.0 N/25 mm.

Preferably the adhesive coating peeling force on the top surface, measured according to DIN EN 1939 (dated November 1996) is 2N/25 mm or greater, 5N/25 mm or greater, 10 N/25 mm or greater, or in some embodiment, 20 N/25 mm or greater.

According to a preferred embodiment of the invention, the support layer and the adhesive coating of the self-adhesive film are designed to be permeable to water vapor. The determination of water vapor permeability is measured according to DIN 53122-1, Part 1, gravimetric process (August 2001) at 23° C. and relative humidity of 85% in a humidification chamber, wherein the bottom surface of the self-adhesive film faces the humidification chamber and the top surface faces the absorption chamber. In some embodiments, the water vapor permeability (WDD) of the self-adhesive film is 2 g/(m²*d) or greater, 5 g/(m²*d) or greater, 5 g/(m²*d) or greater, 10 g/(m²*d) or greater, and 20 g/(m2*d) or greater.

By designing the self-adhesive film according to the invention to be permeable to water vapor, it can be possible to prevent any residual moisture evaporating from the floor, i.e. water vapor from collecting between the floor and the support layer of the self-adhesive film according to the invention, in particular where parquet flooring has just been installed or where floor coverings have been installed onto freshly applied cement pavement that may or may not be completely dry yet, and thus negatively affecting the adhesive properties of the adhesive coating used. In particular, this can prevent a drop in bond strength and possibly consequent worsened detachability. Also, by appropriately designing the self-adhesive film when adhesively installing a floor covering, the formation of mold or the softening of parquet flooring, for example, resulting from water vapor collection can be prevented.

It can be advantageous to achieve water vapor permeability of the support layer and of the adhesive coating by perforating the support layer and/or by perforating the adhesive coating on at least one of the surfaces. This can allow water vapor to permeate the self-adhesive film in a simple way. Perforation according to the invention is not understood to mean that the self-adhesive film is simply prefabricated in sections and that the prescribed sections of the self-adhesive film can be separated from the rest of the self-adhesive film by hand along a series of corresponding perforation holes.

In some embodiments, the support layer and/or the adhesive coating on at least one of the surfaces is provided with a distribution of perforation holes over the entire surface. This can provide the best possible water vapor permeability, in particular for large area use of the self-adhesive film according to the invention.

It can be especially advantageous if the perforation holes in the support layer and in the adhesive coating of at least one of the surfaces are aligned with each other so that direct penetration of any water vapor evaporating from the floor can be possible.

In some embodiments, the perforation holes have a distance from one another of less than 10 cm, wherein the holes have a cross sectional area of preferably less than or equal to 4 mm².

Of course, it is within the scope of the invention to combine a perforated support layer with a perforated adhesive coating on at least one surface and an un-perforated diffusion-capable adhesive coating on the other surface, for example.

It can be advantageous that the support layer be designed essentially flat at least on its bottom surface. Furthermore, it can be advantageous if the adhesive coating is designed essentially flat at least on its bottom surface. In this way, according to an embodiment of the invention that contains perforations, the support layer and/or the adhesive coating of at least the bottom surface can be designed flat at least between the perforation holes, which condition being reflected by the expression “essentially flat”.

In some embodiments of the invention, self-adhesive film is produced by making the perforation holes in the self-adhesive film from below, i.e. by puncturing from the direction of the bottom side surface facing the substrate, for example the floor or stair.

This manner of manufacture can ensure that the self-adhesive film according to the invention is designed essentially flat at least at the bottom surface of the support layer and that the adhesive coating of at least the bottom surface is designed essentially flat, since the ridges of the perforation holes in the support layer are directed upward away from the bottom surface due to the direction of puncture. Furthermore, the adhesive coating of at least the bottom surface can essentially smooth these ridges out.

In an embodiment, the self-adhesive film according to the invention has a fabric and/or tape and/or textile structure on at least one surface that in particular serves maintain the dimensional stability of the self-adhesive film when it is installed and detached.

To improve the manageability of the self-adhesive film according to the invention, it has a removable cover film on at least one of its two surfaces. In some embodiments, the removable cover film is at least on the top surface over the adhesive coating thereon. This can consist of silicone-coated paper or another suitable material, for example. In an embodiment, the cover film is perforated and/or designed to be non-slip. In an embodiment, the self-adhesive film and the cover film are perforated in alignment, the manufacture of which can be accomplished by making the perforation holes in the self-adhesive film from below, i.e. by puncturing from the bottom surface side that faces the substrate, for example the floor or stairs.

It can be especially advantageous if the removable cover film provided on at least one of the two surfaces is perforated with perforation holes that are in alignment preferably with the perforation holes of the support layer and/or the adhesive coating of at least one of the surfaces.

Additionally, or by itself, a removable cover film can be provided on the bottom surface as well. However, in the event that the bond strength of the bottom surface is less than the bond strength of the top surface, this is not absolutely necessary.

The cover film can adhere to the corresponding surface removably in a practically unbroken piece.

According to embodiments of the invention, the self-adhesive film can be designed with a minimum width of 150 mm for wide area coverage of the floor or stairs to be covered with the floor covering or poster, its width being in a range of from 150 mm to 2000 mm, or in a range of from 500 mm to 1500 mm, or in a range or from 600 mm to 1000 mm, wherein its width in the case of use for stairs can be in particular from 200 mm to 250 mm, and for use on floors can be at least 350 mm.

According to embodiments of the invention, the support layer of the self-adhesive film can have a thickness in a range of from 10 to 120 μm, or in a range of from 25 to 75 μm, or in a range of from 50 to 70 μm.

The self-adhesive film can exist in rolled form for purposes of transport. To this end, the self-adhesive film can be wound into a roll. In general, any desired length of the self-adhesive film can then be unwound from the web length of the roll. The self-adhesive film can be pre-fabricated at a specific width and also in specific lengths and/or shapes.

The features of the self-adhesive film according to the invention described above in connection with its application in the installation of floor coverings also apply—to the appropriate extent—in connection with the application thereof in the adhesive attachment of flat, flexible materials such as sheeting, posters or textiles.

An example of the invention is explained in more detail below with the aid of the attached drawings and with reference to preferred embodiments. Shown are:

FIG. 1 a schematic perspective view of a self-adhesive film according to a first embodiment of the invention;

FIG. 2 a schematic perspective top view of a self-adhesive film according to the invention according to a second embodiment of the invention;

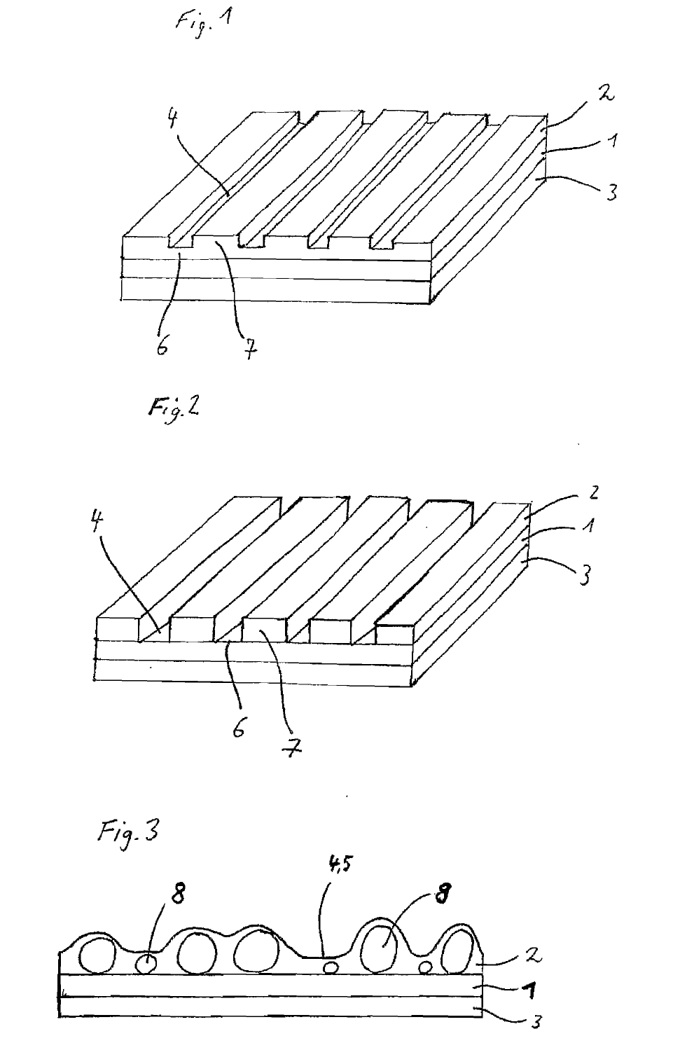

FIG. 3 a schematic cross sectional view of a third embodiment of the invention;

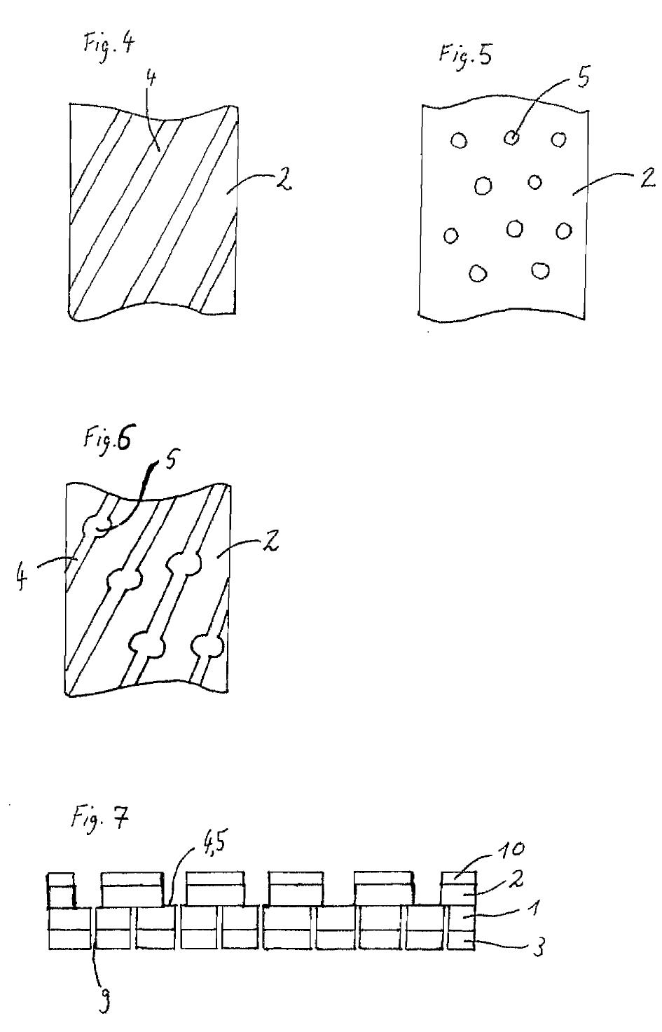

FIG. 4 a schematic top view of a self-adhesive film according to a fourth embodiment of the invention;

FIG. 5 a schematic top view of a self-adhesive film according to a fifth embodiment of the invention;

FIG. 6 a schematic top view of a sixth embodiment of the self-adhesive film according to the invention; and

FIG. 7 a schematic side view of a self-adhesive film according to the invention according to a seventh embodiment of the invention.

FIG. 1 shows a schematic perspective top view of a self-adhesive film according to a first embodiment of the present invention. The inventive purpose of the self adhesive film is to attach a floor covering, in particular a rug, onto a floor, in particular a parquet floor, or onto a stairway, or to attach a poster onto a substrate. The self-adhesive film comprises a support layer 1 made of a plastic film, which is coated with an adhesive coating 2, 3 on a top surface facing the floor covering and on a bottom surface facing the floor or stairway. Adhesive coating 2 is located on the top surface and adhesive coating 3 is located on the bottom surface. According to the embodiment, the self-adhesive film comprises air channels 4 on at least its top surface facing the floor covering locating in a plane that runs perpendicular to the thickness of the self-adhesive film, said air channels and/or air chambers located between the self-adhesive film and the floor covering and facing the floor covering. In the first embodiment shown in FIG. 1, the air channels 4 are provided in the adhesive coating 2 of the top surface, wherein first areas 6 are provided with a thinner adhesive coating 2, alternating with second areas 7 provided with thicker adhesive coating 2, and wherein the first areas 6 constitute the air channels. According to the embodiment, it is preferred for the width of the air channels to be at most 15 mm and most preferred to be at most 0.5 mm, wherein widths in between these values are also possible depending on the application.

Defined air channels 4 are provided which can remain intact or at least largely intact even after the floor covering or poster is installed. Preferably the air channels 4 remain intact at least long enough to allow the trapped air between the self-adhesive film and the floor covering or poster to escape. However, it remains intact for a longer time than this. In the embodiment shown in FIG. 1, the air channels 4 run parallel to the web direction of the self-adhesive film according to the invention. The individual air channels 4 are isolated from one another and are not connected together. The respective air channels 4 can also run all the way to the edges of the respective self-adhesive film in order to allow the air to escape at the edge in the installed situation.

In general, the ratio of the surface area of the air channels 4 and/or the air chambers 5 of the at least one surface to the total area of this at least one surface is no more than 30%, most preferably no more than 10%. Intermediate percentages are also possible depending on the application. This applies to all embodiments of the invention.

Reference is made, in general, to the fact that the orders of magnitude in the schematically illustrated figures do not correspond to reality, in particular the size ratio of the individual layers with respect to one another is not shown to scale for the purposes of better illustration.

FIG. 2 shows a second embodiment of the self-adhesive film according to the invention in a schematic top view. Here, the features according to the invention according to the representation in FIG. 2 correspond to the features of FIG. 1 with the difference being that the first areas 6 do not have any adhesive coating and the second areas 7 are designed as strips of adhesive coating 2.

FIG. 3 shows a third embodiment of the self-adhesive film according to the invention in a lateral cross sectional view. Here, air channels 4 and/or air chambers 5 are provided in the adhesive coating 2 of the top surface by producing an average roughness Ra of from 1 to 300 μm there through the addition of coarse fillers 8.

FIG. 4 shows another embodiment of the invention in a schematic top view. Here, the air channels 4 in the adhesive coating 2 are arranged at an oblique angle with respect to the web direction of the self-adhesive film according to the invention.

FIG. 5 shows another embodiment of the self-adhesive film according to the invention. Here, the air chambers 5 in the adhesive coating 2 are evenly distributed. In the embodiment shown in FIG. 5, the air chambers 5 are designed to be circular. However, any suitable shape is conceivable, in particular square, rectangular, triangular, trapezoidal, rhombic or oval. Multi-angled shapes are also conceivable. In general, the diameter of the air chambers 5 at most range from 15 to 10 mm, and or in some embodiments is less than or equal to 0.5 mm. Intermediate diameters between these can be selected accordingly depending on the application.

FIG. 6 shows a sixth embodiment of the present invention in which both air channels 4 and air chambers 5 are provided together in the adhesive coating 2 and in which the air chambers 5 are connected to the respective air channels 4.

FIG. 7 shows another embodiment of the present invention. Here, at least the support layer 1 and adhesive coating 3 are provided with perforation holes 9. Adhesive coating 2 contains the air channels 4 and air chambers 5 according to the invention, and in addition a removable covering film 10 is provided on at least the top surface. On the left side of the schematic cross sectional view of FIG. 7, at least some of the perforation openings are aligned with the air channels 4 and air chambers 5. On the right side of the illustration in FIG. 7, the perforation openings 9 do not run in alignment with the air channels 4 and the air chambers 5. By combining air channels 4 and/or air chambers 5 and perforation openings 9, it is particularly feasible to avoid air bubbles when installing a self-adhesive film so designed according to the invention since any air between the floor and the self-adhesive film is passed to the air channels 4 and/or air chambers 5 through the perforation openings 9 as well.

In general, the self-adhesive film according to the invention can provide bubble-free and tension-free installation of flat, flexible materials, such as floor coverings, sheeting, posters or textiles while maintaining simple manageability. Also, the self-adhesive film according to the invention can be produced cost-effectively since it requires relatively little engineering to produce the respective product configuration.

What is claimed is:

1. A self-adhesive film having a thickness, comprising: a support layer comprising plastic film and having a top surface and a bottom surface; a first adhesive coating on the top surface; a second adhesive coating on the bottom surface, wherein the first adhesive coating and second adhesive coating can be the same or different; and air conduits on the top surface, wherein the air conduits are chosen from air channels, air chambers, or a combination thereof, are defined by the adhesive coating, and run perpendicular to the thickness of the self-adhesive film, and further wherein the air conduits are not fully enclosed within the adhesive coating.

2. A self-adhesive film according to claim 1, wherein: the first adhesive coating has first portions and second portions, each of the portions having a thickness, and wherein the thickness of the first portion is 0 mm or greater; and the air conduits are defined by the first portions of the adhesive coating having a thickness that is less than the thickness of the second portions.

3. A self-adhesive film according to claim 1, wherein the air conduits are defined by the first adhesive coating having a roughness, wherein the average roughness Ra ranges from 1 to 300 μm.

4. A self-adhesive film according to claim 3, wherein the average roughness Ra ranges from 5 to 200 μm.

5. A self-adhesive film according to claim 4, wherein the average roughness Ra ranges from 10 to 150 μm.

6. A self-adhesive film according to claim 5, wherein the average roughness Ra ranges from 15 to 100 μm.

7. A self-adhesive film according to claim 6, wherein the average roughness Ra ranges from 20 to 75 μm.

8. A self-adhesive film according to claim 3, further comprising coarse fillers within the first adhesive coating, and wherein the first adhesive coating has a thickness and the coarse fillers have an average particle diameter ranging from 0.1 to 10 times the thickness of the first adhesive coating.

9. A self-adhesive film according to claim 8, wherein the coarse fillers have an average particle diameter ranging from 0.3 to 5 times the thickness of the first adhesive coating.

10. A self-adhesive film according to claim 9, wherein the coarse fillers have an average particle diameter ranging from 0.5 to 3 times the thickness of the first adhesive coating.

11. A self-adhesive film according to claims 1, wherein the first adhesive coating has a surface area and the air conduits are defined by no more than 30% of the surface area of the first adhesive coating.

12. A self-adhesive film according to claim 11, wherein the air conduits are defined by no more than 20% of the surface area of the first adhesive coating.

13. A self-adhesive film according to claim 12, wherein the air conduits are defined by no more than 15% of the surface area of the first adhesive coating.

14. A self-adhesive film according to claim 13, wherein the air conduits are defined by no more than 10% of the surface area of the first adhesive coating.

15. A self-adhesive film according to claim 1, wherein the air conduits have a width less than or equal to 15 mm.

16. A self-adhesive film according to claim 15, wherein the width is less than or equal to 10 mm.

17. A self-adhesive film according to claim 16, wherein the width is less than or equal to 5 mm.

18. A self-adhesive film according to claim 17, wherein the width is less than or equal to 3 mm.

19. A self-adhesive film according to claim 18, wherein the width is less than or equal to 1.5 mm.

20. A self-adhesive film according to claim 19, wherein the width is less than or equal to 1 mm.

21. A self-adhesive film according to claim 10, wherein the width is less than or equal to 0.5 mm.

22. A self-adhesive film according to claim 1, wherein the air conduits are separated from each other by a distance ranging from 10 mm to 100 mm.

23. A self-adhesive film according to claim 1, wherein the support layer, the first adhesive coating, and the second adhesive coating are permeable to water vapor.

24. A self-adhesive film according to claim 23, wherein the water vapor permeability (WDD) that is at least 2 g/(m2*d).

25. A self-adhesive film according to claim 24, wherein the WDD is at least 5 g/(m2*d).

26. A self-adhesive film according to claim 25, wherein the WDD is at least 10 g/(m2*d).

27. A self-adhesive film according to claim 26, wherein the WDD is at least 20 g/(m2*d).

28. A self-adhesive film according to claim 23, wherein the support layer and the first adhesive coating, the second adhesive coating, or both have perforation holes having a cross sectional area of less than or equal to 4 mm² distributed over the entire layer and coating at a separation from one another of less than or equal to 10 cm.

29. A self-adhesive film according to claim 28, wherein the first adhesive coating has perforation holes and the perforation holes in the support layer and the perforation holes in the first adhesive coating are arranged in alignment.

30. A self-adhesive film according to claim 28, wherein the second adhesive coating has perforation holes and the perforation holes in the surface layer and the second adhesive coating are arranged in alignment.

31. A self-adhesive film according to claim 1, wherein the support layer is adhesive-embedding on at least its bottom surface, and may be be coronized, provided with a primer coating, contain co-extruded adhesion promoters, or combinations thereof.

32. A self-adhesive film according to claim 1, further comprising an adhesive-embedding layer on the bottom surface of the support layer.

33. A self-adhesive film according to claim 31, wherein the support layer comprises an adhesive-embedding material.

34. A self-adhesive film according to claim 1, wherein self-adhesive film further comprises a barrier against the penetration of additives, softening agents, or both.

35. A self-adhesive film according to claim 34, wherein the self-adhesive film comprises an adhesive-embedding material that functions as the barrier.

35. A self-adhesive film according to claim 1, wherein the bottom surface of the support layer is essentially flat.

36. A self-adhesive film according to claim 1, wherein the second adhesive coating is essentially flat.

37. A self-adhesive film according to claim 1, wherein the second adhesive coating has a bond strength, the first adhesive coating has a bond strength and the bond strength of the second adhesive coating is less than the bond strength of the first adhesive coating.

38. A self-adhesive film according to claim 37, wherein the top surface has a higher average adhesive application weight than the bottom surface.

39. A self-adhesive film according to claim 38, wherein the average adhesive application weight in the dry state on at least the top surface ranges from 5 to 250 g/m2.

40. A self-adhesive film according to claim 39, wherein the average adhesive application weight in the dry state on at least the top surface ranges from 50 to 150 g/m2.

41. A self-adhesive film according to claim 40, wherein the average adhesive application weight in the dry state on at least the top surface ranges from 10 to 80 g/m2.

42. A self-adhesive film according to claim 1, wherein the first adhesive coating, the second adhesive coating, or both is chosen from: acrylate-based dispersions, optionally enriched with resins and containing UV and anti-aging protection; solvent-based materials; materials based on UV, electron-beam or thermal cross-linking; and materials based on a hot melt adhesives.

43. A self-adhesive film according to claim 42, wherein the first and second adhesive coatings are permeable to water vapor and the first adhesive coating comprises an adhesive resistant to softening agents.

44. A self-adhesive film according to claim 1, wherein the first adhesive coating and the second adhesive coating comprise different adhesives.

45. A self-adhesive film according to claim 1, wherein the first adhesive coating and the second adhesive coating have bond strengths, and the bond strength of the first adhesive coating ranges from 0.5 N/25 mm to 15 N/25 mm, and the bond strength of the second adhesive coating is at least 2 N/25 mm.

46. A self-adhesive coating according to claim 45, wherein the bond strength of the first adhesive coating ranges from 1.0 N/25 mm to 10 N/25 mm, and the bond strength of the second adhesive coating is at least 5 N/26 mm.

47. A self-adhesive coating according to claim 46, wherein the bond strength of the first adhesive coating ranges from 2.0 N/25 mm to 8.0 N/25 mm, and the bond strength of the second adhesive coating is at least 10 N/25 mm.

48. A self-adhesive coating according to claim 47, wherein the bond strength of the first adhesive coating ranges from 3.0 N/25 mm to 6.0 N/25 mm, and the bond strength of the second adhesive coating is at least 20 N/25 mm.

49. A self-adhesive film according claim 1, further comprising a removable cover film on the first adhesive coating, the second adhesive coating, or both.

50. A self-adhesive film according to claim 28, further comprising a removable cover film on the first adhesive coating, the wherein the removable cover film has perforation holes in alignment with the perforation holes of at least one of the support layer, the first adhesive coating, or the second adhesive coating.

51. A self-adhesive film according claim 1, wherein the film has a width of at least 150 mm.

52. A self-adhesive film according to claim 51, wherein the width of the film ranges from 150 mm to 2000 mm.

53. A self-adhesive film according to claim 52, wherein the width of the film ranges from 500 mm to 1500 mm.

54. A self-adhesive film according to claim 53, wherein the width of the film ranges from 600 mm to 1000 mm.

55. A self-adhesive film according to claim 54, wherein the width of the film ranges from 200 mm to 250 mm.

56. A self-adhesive film according to claim 52, wherein the width of the film is 350 mm or greater.

57. A self-adhesive film according to claim 1, wherein the support layer has a thickness ranging from 10 to 120 μm.

58. A self-adhesive film according to claim 57, wherein the thickness of the support layer ranges from 25 to 75 μm.

59. A self-adhesive film according to claim 58, wherein the thickness of the support layer ranges from 50 to 70 μm.

60. A self-adhesive film according to claim 1, wherein the self-adhesive film is wound into a roll.
